(19) United States
(12) Patent Application Publication
(10) Pub. No.: US 2015/0359249 A1
(43) Pub. Date: Dec. 17, 2015

(54) PUFFED SNACK FOOD PRODUCT AND PROCESS TO MAKE THE SAME

(71) Applicant: MOM Brands Company, Lakeville, MN (US)

(72) Inventors: Joel S. Matasovsky, Golden Valley, MN (US); David K. Duffy, Maple Grove, MN (US)

(21) Appl. No.: 14/737,265

(22) Filed: Jun. 11, 2015

Related U.S. Application Data
(60) Provisional application No. 62/012,162, filed on Jun. 13, 2014.

(51) Int. Cl. A23L 1/217; A23L 1/00

(52) U.S. Cl. CPC A23L 1/2175; A23L 1/0076; A23L 1/0082; A23V 2002/00

(57) ABSTRACT

A crispy and puffy snack food, such as a chip, and method of making the same is disclosed. The method includes mixing potato flour with oil and water and cooking the mixture; adding more water and extruding the cooked mixture; rolling the extruded mixture to a sheet; cutting the sheet into shapes; drying the shapes; puffing the shapes; and optionally coating the puffed shapes with oil, salt, and/or seasonings. The shapes may be round or polygonal with a diameter or sides about 1.3 to about 5 cm in length and have a bulk density of about 60 to about 120 g/L and an undulating surface due to trapped air pockets. The snack food can include other vegetable ingredients and flavorings.

### CROSS-REFERENCE TO RELATED APPLICATIONS

This application claims the benefit of U.S. Provisional Application Ser. No. 62/012,162, filed Jun. 13, 2014, entitled “Puffed Snack Food Product and Process to Make the Same,” which is incorporated by reference herein in its entirety.

### BACKGROUND

Many conventional snack foods, such as potato chips and tortilla chips, are produced by frying the chips in an oil fryer, resulting in a chip having a pleasingly crispy and light texture but a high fat content. For example, the fat content of a conventional potato chip is typically 30% or greater. Conventional fried snack foods are also typically heavily salted, further contributing to their poor nutritional value. Foods with such high fat and calorie content make it challenging to maintain a healthy diet and avoid health risks associated with high calorie, high fat, and/or high sodium diets. Without giving up the desire for a pleasing taste and mouth feel and ability to enjoy snack foods, increasingly health-conscious consumers are looking for healthier alternatives to conventional fried snack foods.

### SUMMARY

A snack food and method of making the same is disclosure. The method comprises mixing potato flour with oil to produce a first mixture; adding water to the first mixture and cooking the first mixture at about 50° C.; adding water to the cooked mixture and extruding the cooked mixture at about 102 to about 135° C.; rolling the extruded mixture to a sheet; cutting the sheet into shapes; drying the shapes to a moisture of about 9 to about 13%; puffing the shapes; and optionally coating the puffed shapes with oil, salt, and/or seasonings. The shapes can be puffed in a rotary dryer at a temperature of about 200 to about 260° C. The shapes may be round or polygonal with a diameter or sides about 1.3 to about 5 cm in length and have a bulk density of about 60 to about 120 g/L and an undulating surface and a puffed and crispy texture. The snack food may comprise about 39 to about 96% potato flour by weight; 0 to about 7% starch by weight; about 0 to about 35% vegetable flakes by weight; about 2 to about 13% oil by weight; about 0.5 to about 2.5% salt by weight; and about 0 to about 12% flavorings by weight.

### BRIEF DESCRIPTION OF DRAWINGS

FIG. 1 shows an embodiment of the process for making potato snack foods.

FIG. 2 shows an embodiment of the process of FIG. 1.

FIG. 3 is a schematic cross section of a snack food according to an embodiment.

FIG. 4 shows an embodiment of the system for implementing the process of FIG. 1.

FIGS. 5A-5D show embodiments of snack foods produced by the process of FIG. 1.

### DETAILED DESCRIPTION

Many conventional snack foods, such as potato chips and popcorn, are heavily salted and include high concentrations of fat. The conventional potato chip is cooked by deep-fat frying raw, sliced potatoes to produce a crispy, light texture. As the moisture in the potato heats up and escapes, expanding the starch, the chip absorbs large amounts of fat. Baked chips are available as a lower fat alternative to fried chips. For example, baked potato chips are cooked by baking the potato slices in an oven (e.g., microwave and/or hot air oven). However, baked chips often lack the desired light and crispy texture of fried chips. It would, therefore, be desirable to provide for a potato snack food with a lower fat content while maintaining the pleasing mouthfeel and light and crunchy texture of a fried product.

A snack food (e.g., a potato snack food; e.g., a chip) that is lower in fat than conventional potato snack foods, e.g., potato chips, and has a light, crispy texture is disclosed. According to embodiments, the snack food of the present disclosure includes less than 10% fat. Instead of deep-fat frying, the process for the manufacture of the snack food of the present disclosure utilizes extrusion and toasting to produce a snack food product having a light and crispy texture, similar to a fried snack food, with lower fat content.

The snack food product of the disclosure comprises a puffed texture that is light and crunchy, having a pleasing mouth feel. The snack food product can be a chip defined by any suitable shape and size including geometric shapes, such as squares, rectangles, triangles, ovals, circles, hexagons, and the like, and novelty shapes, such as animals, stars, and novelty characters, or any other regular or irregular shape. The size of the chip can be about 0.5-3 inches in diameter, or about 0.5-2 inches (about 1.3-5 cm), with a thickness of about 0.125-0.25 inches, or about 0.080 inches (approximately 0.2 cm). The thickness of the chip can vary such that one area of the chip has one thickness and another area of the chip has another thickness. The shape and surface of the chip can be irregular and/or uneven having an undulating surface. The texture of the snack food product is characterized by a plurality of air pockets of varying sizes throughout the chip. The air pockets within the chip (i.e., distributed throughout a matrix of the chip) contribute to a puffy texture and an undulating surface of the chip. Due to the plurality of air pockets, the chips have a low bulk density. In embodiments, the snack food product comprises a bulk density from about 60 to about 120 g/L, from about 60 to about 80 g/L, or from about 80 to about 120 g/L.

The term “starch” is used here to refer to starch as an ingredient, e.g., corn starch, potato starch, wheat starch, rice starch, etc. The term “total starch” is used to refer to starch as part of a composition and as can be measured by a wet chemistry assay, such as AOAC Method 996.11.

The term “flour” is used here to refer to ground particles and is understood to include various particle sizes, including granules and flakes, unless otherwise specified. For example, the term “potato flour” encompasses finely ground potato flour, as well as potato flakes and potato granules.

The composition of the snack food product is dependent on the ingredients used to make the product. In embodiments, the snack food product comprises from about 39 to about 96% flour, starch, or a combination thereof by weight, from about 0 to about 13% oil by weight, and from about 1 to about 7% water by weight. In an embodiment, the snack food product comprises from about 74 to about 96% flour, starch, or a combination thereof by weight, from about 0 to about 13% oil by weight, and from about 2 to about 7% water by weight. In an embodiment, the snack food product comprises from about 39 to about 96% flour by weight, from 0 to about 7% starch by weight, from about 2 to about 13% oil by weight, and from about 1 to about 7% water by weight. In an embodiment, the snack food product comprises from about 88 to about 89% flour by weight, from about 8 to about 10% oil by weight, and from about 4 to about 6% water by weight. In another embodiment, the snack food product comprises from about 73 to about 8781660v1 374% flour by weight, from about 12 to about 13% oil by weight, from about 8 to about 23% seasonings/flavorings by weight and from about 4 to about 6% water by weight.

In other embodiments, the snack food product comprises from about 39 to about 86% flour by weight, from about 0 to about 7% starch by weight, 0 to about 35% vegetable flakes by weight, from about 2 to about 13% oil by weight, and from about 1 to about 7% water by weight.

In an embodiment, the snack food product comprises from about 39 to about 86% flour, starch, or a combination thereof by weight, from about 2 to about 35% vegetable flakes by weight, from about 2 to about 13% oil by weight, and from about 3 to about 7% water by weight. In another embodiment, the snack food product comprises from about 85 to about 88% starch by weight, from about 2 to about 5% vegetable flakes by weight, from about 9 to about 11% oil by weight, and from about 3 to about 5% water by weight. In yet another embodiment, the snack food product comprises from about 39 to about 41% starch by weight, from about 33 to about 35% vegetable flakes by weight, from about 12 to about 13% oil by weight, and from about 4 to about 6% water by weight.

The flour can be a vegetable or root vegetable flour or root vegetable granules or flakes, such as potato, sweet potato, corn, carrot, beet, arrowroot, and the like; grain flour, such as cereal grains and seeds (e.g., wheat, oat, barley, rye, rice, quinoa, millet, sorghum, triticale, sesame, flax, hemp, poppy, chia, and the like); legume flour (e.g., peas, beans, lentils, peanuts, and the like); or combination thereof. Examples of flours include but are not limited to wheat flour, bean flour, barley flour, chickpea flour, green pea flour, hazelnut flour, buckwheat flour, corn flour, corn meal, coconut flour, hemp flour, nut flour, spelt flour, soy flour, millet flour, flaxseed flour, almond flour, potato flour, potato starch flour, peanut flour, quinoa flour, whole grain flour, rice flour, rye flour, semolina, sorghum flour, tapioca flour, and combinations thereof In embodiments, the snack food product comprises from about 39 to about 96% flour by weight, from about 50 to about 96% flour by weight, from about 74 to about 96% flour by weight, from about 74 to about 80% flour by weight, or from about 87 to about 89% flour by weight.

The starch can be a vegetable or root vegetable starch, grain starch, bean starch, or combination thereof Examples include but are not limited to corn starch, potato starch, arrowroot starch, rice starch, tapioca starch, soy starch, sorghum starch, soy starch, sweet potato starch, and combinations thereof. In embodiments, the snack food product comprises from about 1 to about 10% starch by weight, from about 2 to about 8% starch by weight, from 0 to about 7% starch by weight, from about 3 to about 7% starch by weight, from about 2 to about 4% starch by weight, or from about 6 to about 8% starch by weight.

The vegetable flakes can be flakes of a vegetable or root vegetable. Examples of vegetable flakes include but are not limited to potato flakes or sweet potato flakes. In embodiments, the snack food product comprises 0 to about 35% vegetable flakes by weight, from about 2 to about 35% vegetable flakes by weight, from about 4 to about 33% vegetable flakes by weight, from about 5 to about 7% vegetable flakes by weight, from about 2 to about 4% vegetable flakes by weight, or from about 33 to about 35% vegetable flakes by weight.

The amount of total starch in the snack food may be about 74 to about 80% by weight, or about 60 to about 70% by weight. The flour, starch, and vegetable flakes may all contribute to the amount of total starch in the product.

The oil is a food grade oil, generally a vegetable oil or blend of vegetable oils. Examples of suitable oils include but are not limited to canola oil, rapeseed oil, sunflower seed oil, peanut oil, coconut oil, soybean oil, and mixtures thereof In embodiments, the snack food product comprises from about 0 to about 13% oil by weight, from about 2 to about 13% oil by weight, from about 8 to about 13% oil by weight, or from about 2 to about 4% oil by weight.

The snack food product can be supplemented to include protein, fiber, minerals, vitamins, and other macro and micro nutrients. For example, the snack food may comprise about 2-20% protein, and about 2-20% fiber. The nutrient content of the snack food may be adjusted as desired. Examples of vitamins include, but are not limited to, vitamin A, vitamin B5, vitamin B6, vitamin B12, vitamin C, biotin, folate, niacin, riboflavin, thiamine, and vitamin E in the form of tocopherols. In embodiments, the snack food product comprises from about 0.1 to about 1% supplemental vitamins by weight, from about 1 to about 2% supplemental vitamins by weight, or from about 2 to about 4% supplemental vitamins by weight. Examples of minerals include, but are not limited, calcium, iron, potassium, magnesium, and zinc. In embodiments, the snack food product comprises from about 0.5 to about 1% supplemental minerals by weight, from about 1 to about 1.5% supplemental minerals by weight, or from about 1.5 to about 2% supplemental minerals by weight.

The snack food product can also include additives, such as salt, flavorants, preservatives, and colorings. The salt can be of different geometric shapes, such as flakes or cubes. Additionally, the salt can be of a coarse grind or of a fine grind. Other salts and salt shapes are possible. The salt can include sodium salts, potassium salts, magnesium salts, manganese salts, and mixtures thereof Suitable salts include, but are not limited to, table salt, iodized table salt, kosher table salt, sea salt, fleur de sel, smoked salt, and finishing salt. In embodiments, the snack food product comprises from about 0.2 to about 2.5% salt by weight, from about 0.5 to about 2.5% salt by weight, from about 0.5 to about 2% salt by weight, from about 1 to about 2% salt by weight, or from about 2 to about 2.5% salt by weight.

The flavorant can be a seasoning including one or more flavors, for example, garlic, pepper, honey, mustard, barbeque, mesquite, ranch, onion, bacon, cheddar cheese, buffalo wing, jalapeno, peanut butter, parmesan, sesame seed, chipotle, sugar, cinnamon, and the like. In embodiments, the snack food product comprises 0 to about 12% flavorant by weight, from about 8 to about 12% flavorant by weight, from about 8 to about 10% flavorant by weight, or from about 10 to about 12% flavorant by weight.

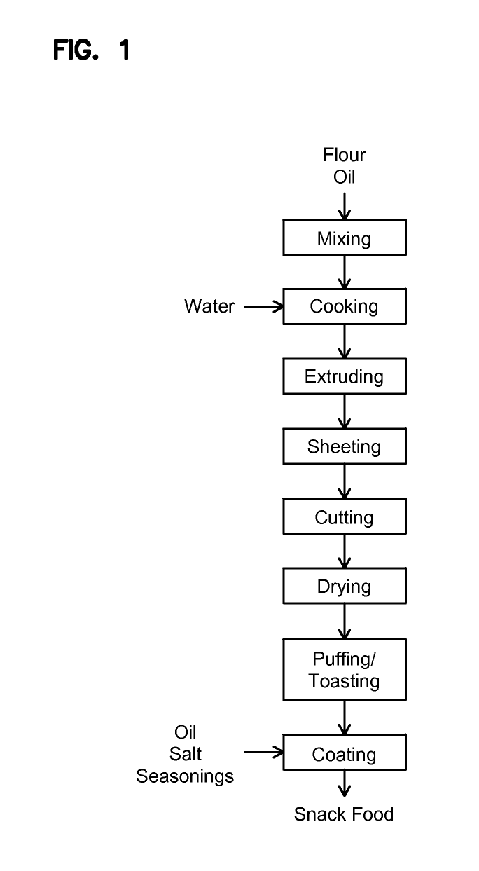

FIG. 1 shows a schematic process flow diagram of the process for making the potato snack food of the present disclosure. The process includes the steps of mixing, cooking, extruding, sheeting, cutting, drying, toasting or “puffing,” and coating.

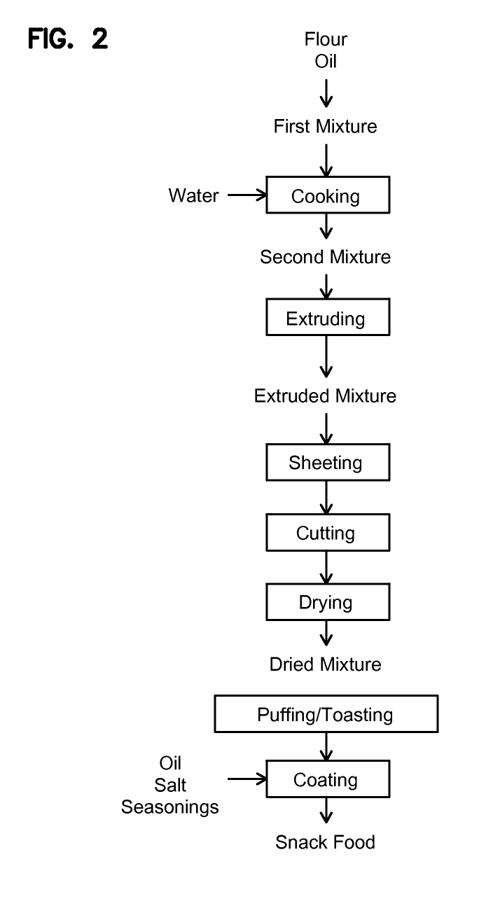

According to embodiments, as shown in FIG. 2, flour or flour mixture, such as potato flour, optionally mixed with other types of flour, is mixed with oil to produce a first mixture. In an exemplary embodiment, the first mixture comprises about 90 to about 98%, or about 92 o about 96%, or about 94% potato flour, and about 2 to about 10%, or about 4 to about 8%, or about 6% oil. Any suitable food grade oil (e.g., vegetable oil) can be used, such as canola oil, rapeseed oil, sunflower seed oil, peanut oil, soybean oil, etc., and mixtures thereof The potato flour may comprise about 85 about 90% starch and about 7 about 10% moisture. Any suitable potato flour of various compositions, sourced from any variety of potatoes may be used. According to alternative embodiments, the first mixture may comprise at least about 39% potato flour, about 2 about 35% flour of other vegetable, root vegetable, fruit, or grain origin, and about 2 about 10%, or about 4 to about 8%, or about 6% oil. For example, the mixture may comprise other vegetable or root vegetable flour, such as potato, sweet potato, corn, carrot, beet, arrowroot, and the like; grain flour, such as cereal grains and seeds (e.g., wheat, oat, barley, rye, rice, quina, millet, sorghum, triticale, sesame, flax, hemp, poppy, chia, and the like); legume flour (e.g., peas, beans, lentils, peanuts, and the like); or combination thereof. The first mixture may further comprise additional components to increase its protein content, fiber content, vitamin and/or mineral content, or to enhance its flavor or appearance, or to extend its shelf life. The additional components may include, for example, protein flour (e.g., soy protein), fiber (e.g., soluble corn fiber), vitamin and mineral powders, other micro or macro nutrients, flavorants, colorings, preservatives, and salt.

At some point, water is also incorporated into the first mixture. The water can be incorporated when the ingredients in the first mixture are initially combined. The water can also be incorporated after the ingredients in the first mixture are combined and the mixture is being prepared for cooking. And the water can be added in both steps, with a portion being added during mixing and a portion being added during cooking. Regardless of when the water is added, by the time the first mixture is cooked, the first mixture may include about 10 to about 20%, or about 14 to about 18%, or about 16 to about 17% water.

The first mixture can be cooked at a temperature of about 50 to about 80° C., or about 50° C. at a pressure of about 1,000 to about 2,000 psi for about 20 to about 120 seconds, or about 30 to about 90 seconds. The cooking time may be shortened for higher cooking temperatures and increased for lower cooking temperatures. The cooking temperature and time may also be adjusted based on the composition (e.g., fat content or starch content) of the first mixture.

The temperature of the mixture is increased to about 98 to about 140° C., or to about 98 to about 135° C., or to about 98 to about 121° C., or to about 102 to about 121° C., and the cooked mixture is extruded through a die. Any suitable extruder and extruder die can be used. For example, the extruder may be a screw type extruder having one or more screws (e.g., a single screw extruder or a twin screw extruder). The die may have one or more openings of about 0.079 to about 0.375 inches or about 2.0 to about 9.5 mm in diameter. The moisture content of the extruded product can be about 18 to about 35%, or about 21%. As the cooked mixture is extruded through the die, air and water in the mixture create an air cell structure with small pockets of gas throughout the mixture, causing the mixture to expand greatly, e.g., about 5 to about 10 fold. The air pockets within the chip contribute to a puffy texture, low bulk density, and an undulating surface of the chip.

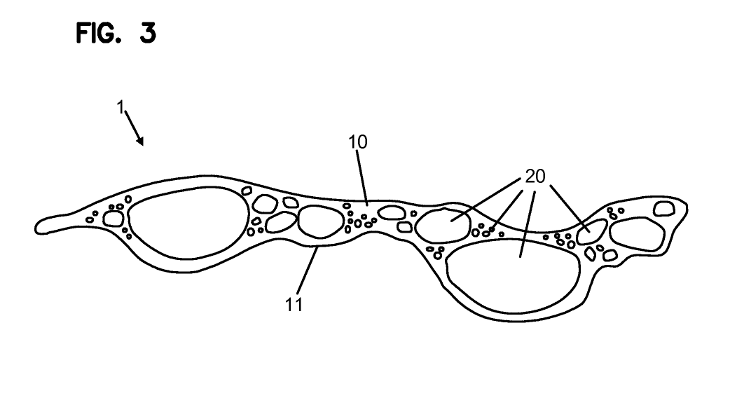

A schematic cross sectional view of a chip 1 produced according to the embodiments is shown in FIG. 3. The chip 1 has a matrix 10 that is formed from the mixture. Within the matrix 10, the chip comprises a plurality of air pockets 20. The air pockets 20 may be of varying sizes and may contribute to the undulating contours of the surface 11 of the chip 1. The plurality of air pockets 20 also contribute to a low bulk density of the chip 1.

According to an embodiment, the temperature of the mixture is increased as the product is extruded. In embodiments, the extruder comprises multiple zones, where the temperature of the mixture can be controlled in stages. For example, the mixture may be cooked/heated to the desired temperature in a first stage and extruded in a second stage. Alternatively, the mixture may be heated to a first temperature in a first stage, and to a second temperature in a second stage either as the mixture is extruded or prior to the mixture being extruded. Thus, the cooking and extruding may both take place within a single extruder where the first mixture is placed within an extruder and simultaneously extruded and cooked within the extruder. Alternatively, the cooking and extruding steps may be separated (e.g., not simultaneous). For example, the cooking and extruding may take place in separate pieces of equipment or at separate times. The extruded product can be flattened or “sheeted” using, for example, rollers. In an exemplary embodiment, the extruded product is sheeted to a thickness of about 0.045 to about 0.090 inches, or about 0.080 inches (approximately 0.2 cm). The sheeted product can be cut to any desirable shape, such as squares, rectangles, rounds, hexagons, or any other regular or irregular shape. The size of the cut shapes can be any suitable shape for a snack product. For example, the shapes can be about 0.5 to about 3 inches in diameter, or about 0.5 to about 2 inches (about 1.3 to about 5 cm).

The cut shapes are dried in a dryer or a combination of dryers, such as a rotary dryer and/or a tray dryer. The drying step is intended to remove mainly surface moisture to facilitate the following toasting step and to prevent the shapes from sticking together. According to an embodiment, the cut shapes are dried to a moisture content of about 9 to about 13%, or about 11 to about 12%. The temperature of the dryer may be any suitable temperature for drying the cut shapes to the desired moisture level and may depend on the type of dryer used. For example, temperature of a rotary dryer can be about 150 to about 220° F., or about 160 to about 180° F. The drying time can be adjusted to achieve the desired moisture level.

The dried cut shapes are further heated to toast or “puff” the shapes to provide them with the desired texture. The shapes can be toasted or puffed in a rotary dryer, a fluidized bed dryer, or any other suitable dryer. In an exemplary embodiment, the dried cut shapes are toasted in a rotary dryer at a temperature of about 350 to about 450° F. (about 177 to about 232° C.), or about 450 to about 500° F. (about 232 to about 260° C.) to a final moisture content of about 1 to about 7%, or about 3 to about 7%, or about 6 to about 7%. The toasting time can be adjusted to achieve the desired moisture level and browning of the shapes, and will vary based on multiple factors, such as composition and moisture content of the shapes at the beginning of the puffing step, and size of the shapes. For example, at a temperature of about 490° F., the toasting time can be about 45 to about 90 seconds, or about 1 min. The toasting step will preferably result in a light and crunchy texture with light browning. The toasting step can be monitored by monitoring the bulk density and color of the product. The bulk density of the toasted and puffed shapes is in the range of 60 to about 80 g/L, or about 80 to about 120 g/L. The color of the toasted shapes can be monitored visually or by using a colorimeter.

The toasted shapes are finally coated with oil, salt and/or seasonings. In an exemplary embodiment, the toasted shapes are coated in an enrobing drum with about 2 to about 8%, or about 5% oil as measured by weight of the toasted shapes, and with about 0.5 to about 2.5%, or about 1.5% salt. The toasted shapes can further be coated with flavorants or seasonings, such as herbs, spices, onion powder, garlic powder, pepper, honey, mustard, barbeque, mesquite, ranch, bacon, cheddar cheese, buffalo wing, jalapeno, peanut butter, parmesan, sesame seed, chipotle, or any other suitable flavorings. The final composition of the snack product, according to embodiments, is about 74-80% potato flour (of which about 88% is starch), about 4% moisture, about 10-13% oil, and about 8-12% seasoning or about 1.5% salt.

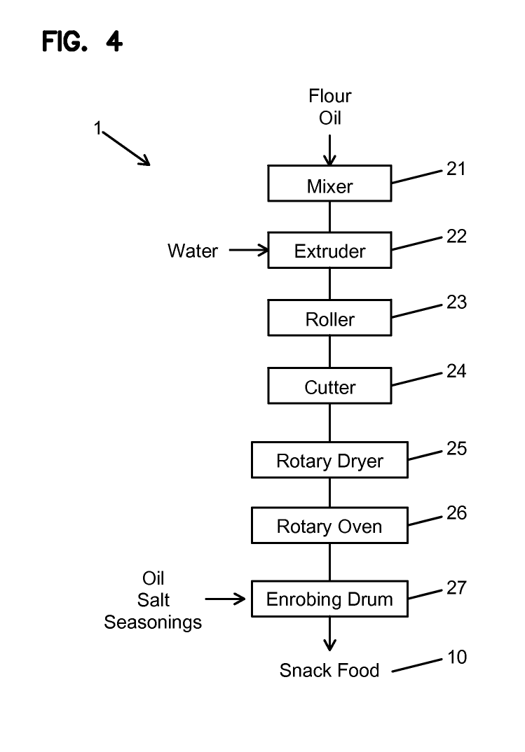

FIG. 4 shows an exemplary, non-limiting embodiment of a system 1 for implementing the process for producing a snack food 10. The system 1 may comprise at least a mixer 21, an extruder 22, a roller 23, a cutter 24, a rotary dryer 25, a rotary oven 26, and an enrobing drum 27. The components of the system 1 may alternatively be substituted with any other suitable components that produce the same result. For example, instead of a rotary dryer, another type of dryer, such as a sheet dryer or a fluidized bed dryer, may be used. The system 1 may also include additional components. For example, the system 1 may include a conveyor belt for moving the products and intermediate products along the process. The system 1 may also include a packing assembly.

### EXAMPLE

Potato snacks were produced in an experimental batch according to the process of the present disclosure. A first mixture was produced by mixing 94% of potato flour and 6% of canola oil. 2.5% of water was added to the dough while the dough was cooked in a twin screw extruder at 50° C. (122° F.). The cooked mixture was mixed with 16.5% water (based on the weight of the mixture) and extruded at a temperature of about 130° C. The extruded mixture was sheeted into a thickness of 0.080 inches and cut into shapes. The cut shapes were first dried in a rotary dryer to about 17% moisture and then in a tray dryer at 180° F. to about 12% moisture. The shapes were toasted in a rotary oven at 490° F., resulting in a moisture content of 6%. The toasted shapes were coated with oil and salt in an enrobing drum. About 5% canola oil and 1.5% salt (based on the weight of the toasted product) were added to the toasted product. The resulting potato snacks were found have a puffed shape and a pleasing, light and crispy texture and mouth feel.

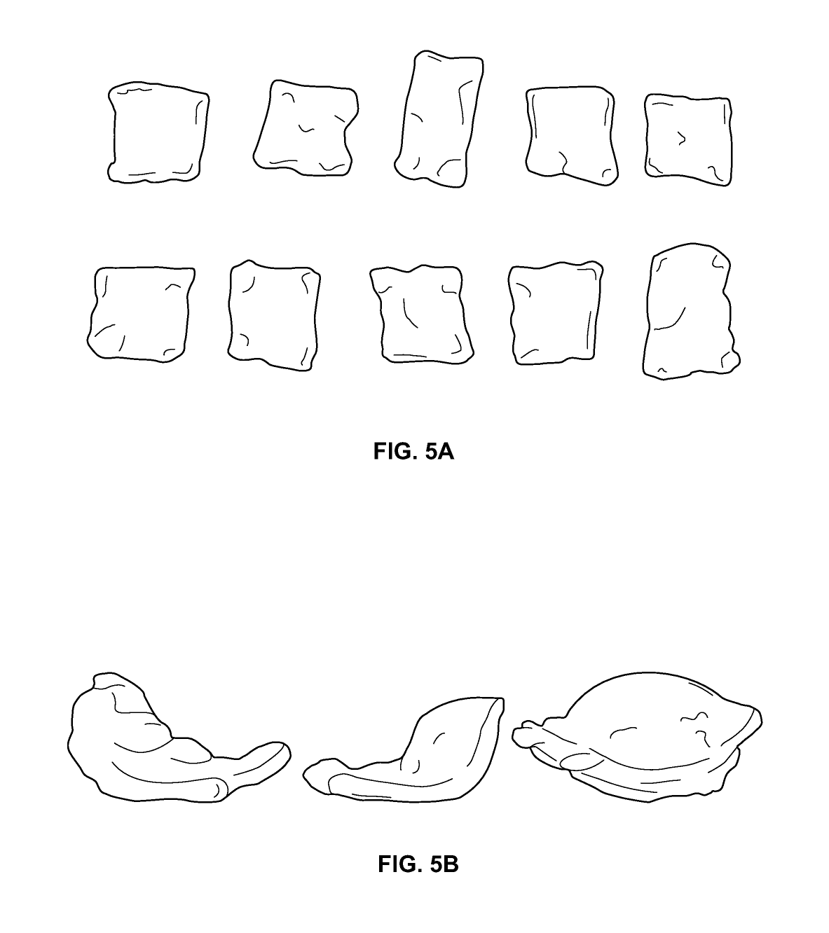

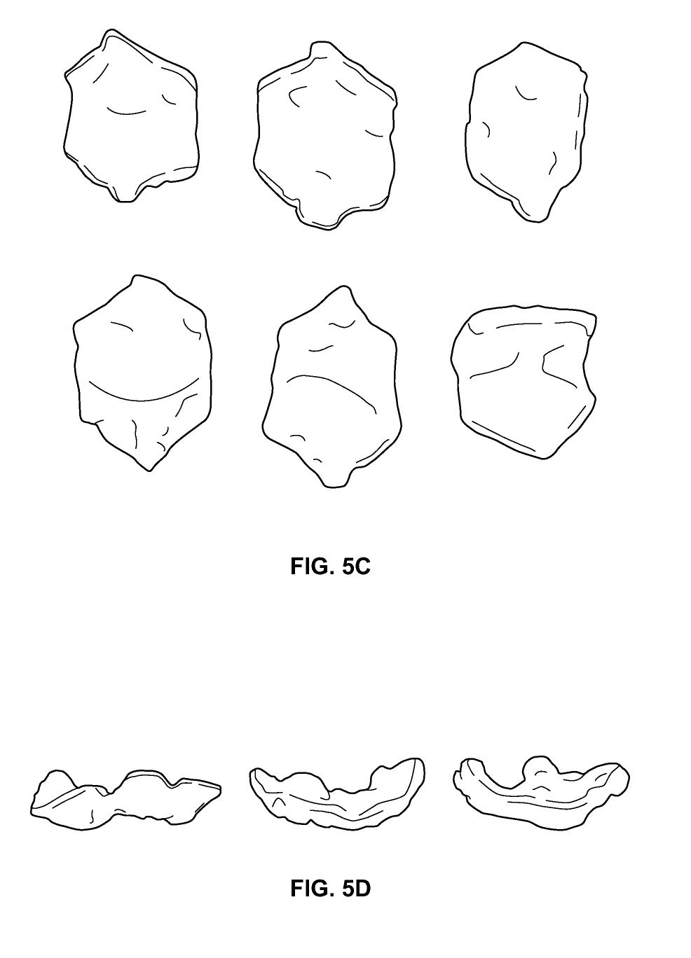

Drawings of the various shapes and sizes of the potato snacks are shown in FIGS. 5A-5D.

While certain embodiments of the invention have been described, other embodiments may exist. While the specification includes a detailed description, the invention's scope is indicated by the following claims. Furthermore, while the specification has been described in language specific to structural features and/or methodological acts, the claims are not limited to the features or acts described above. Rather, the specific features and acts described above are disclosed as illustrative aspects and embodiments of the invention. Various other aspects, embodiments, modifications, and equivalents thereof which, after reading the description herein, may suggest themselves to one of ordinary skill in the art without departing from the spirit of the present invention or the scope of the claimed subject matter.

What is claimed is:

1. A method for producing a potato snack food comprising:
(a) mixing potato flour with oil to produce a first mixture;
(b) cooking the first mixture;
(c) extruding the first mixture at about 102 to about 135° C.;
(d) rolling the extruded mixture to a sheet;
(e) cutting the sheet into shapes;
(f) drying the shapes to a moisture of about 9 to about 13%;
(g) puffing the shapes; and
(h) optionally coating the puffed shapes with oil, salt, and/or seasonings.

2. The method of claim 1, wherein the first mixture is cooked at 50° C.

3. The method of claim 1, wherein cooking the first mixture and extruding the first mixture take place simultaneously.

4. The method of claim 1, wherein cooking the first mixture and extruding the first mixture do not take place simultaneously.

5. The method of claim 1, wherein the shapes are puffed in a rotary dryer at a temperature of about 200 to about 260° C.

6. The method of claim 1, wherein the shapes comprise polygons with sides about 1.3 to about 5 cm in length.

7. The method of claim 1, wherein the shapes comprise rectangles.

8. The method of claim 1, wherein the potato snack food comprises about 39 to about 96% flour and about 2 to about 13% oil.

9. The method of claim 1, wherein the potato snack food comprises an undulating surface and a puffed and crispy texture.

10. The method of claim 9, wherein the potato snack food comprises a bulk density of about 60 to about 120 g/L.

11. An extruded and toasted snack food, comprising
a. about 39 to about 96% flour by weight;
b. 0 to about 7% starch by weight;
c. 0 to about 35% vegetable flakes by weight;
d. about 2 to about 13% oil by weight;
e. about 0.5 to about 2.5% salt by weight; and
f. 0 to about 12% flavorings by weight;
wherein the snack food comprises a puffed and crispy texture having a bulk density of about 60 to about 120 g/L.

12. The snack food of claim 11, wherein the vegetable flakes comprise potato.

13. The snack food of claim 11, wherein the snack food comprises a moisture content of about 1 about 7% by weight.

14. The snack food of claim 11, wherein the snack food comprises a polygonal shape with sides about 1.3 to about 5 cm in length.

15. The snack food of claim 11, wherein the snack food comprises a rectangular shape.

16. The snack food of claim 11, wherein the snack food comprises about 8 to about 10% oil by weight.

17. A snack food produced by the method of claim 5, wherein the snack food comprises an undulating surface and a puffed and crispy texture.
